(19) United States
(12) Patent Application Publication
(10) Pub. No.: US 2009/0328078 A1
(43) Pub. Date: Dec. 31, 2009

(54) Execution of Embedded System Applications

(76) Inventors: Frank Siegemund, Bellevue, WA (US); Alain Gefflaut, Herzogenrath (DE); Matthias Neugebauer, Aachen (DE)

Correspondence Address: Lewis C. Lee;Lee & Hayes, PLLC, Suite 500, 421 W. Riverside Avenue, Spokane, WA, 99201, US

(21) Appl. No.: 12/146,882

(22) Filed: Jun. 26, 2008

(51) Int. Cl. G06F 9/46

(52) U.S. Cl. 719/328

(57) ABSTRACT

A method of executing embedded system applications is disclosed. In an embodiment, an embedded system stores a software application for processing data collected by the embedded system and/or for controlling the embedded system. The embedded system transmits the application to a nearby computing device. The computing device executes the application using its own processing capability. The application contains instructions which, when executed, cause the computing device to interact with the embedded system. This may result in the computing device controlling the embedded system or in data being downloaded from the embedded system and processed by the computing device.

### BACKGROUND

Embedded systems are commonly used to carry out computing tasks. Usually, embedded systems are specialized, having one or very few functions. Embedded systems have limited resources such as memory and processing capabilities with which to perform tasks. An example of an embedded system is a sensor node. A sensor node gathers information about its environment by measuring conditions such as light or temperature levels and may perform rudimentary processing of the information or supply the gathered information to other computing devices with more processing capability.

The embodiments described below are not limited to implementations which solve any or all of the disadvantages of executing known embedded system applications.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A method of executing embedded system applications is disclosed. In an embodiment, an embedded system stores a software application for processing data collected by the embedded system and/or for controlling the embedded system. The embedded system transmits the application to a nearby computing device. The computing device executes the application using its own processing capability. The application contains instructions which, when executed, cause the computing device to interact with the embedded system. This may result in the computing device controlling the embedded system or in data being downloaded from the embedded system and processed by the computing device.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of an embedded system and a computing device;

FIG. 2 is a schematic diagram of a sensor node;

FIG. 3 is a schematic diagram of a gateway computing device capable of communicating with a sensor node;

FIG. 4 is a schematic diagram of a sensor node application assembly;

FIG. 5 is a flow diagram of a method of executing a sensor node application;

FIG. 6 is a flow diagram of the steps carried out in execution of a sensor node application;

FIG. 7 is a schematic diagram of a wireless sensor network;

FIG. 8 is a flow diagram of a method of accessing data from the wireless sensor network; and

FIG. 9 illustrates an exemplary computing-based device in which embodiments of a gateway and/or backend computing device may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a sensor node, the system described is provided as an example and not a limitation. As those skilled in the art will appreciate, the present examples are suitable for use in a variety of different types of embedded systems.

The term ‘embedded system’ as used herein refers to hardware components which are dedicated to performing one or limited computing task(s). Embedded systems therefore store programming which allow that or those computing tasks to be carried out.

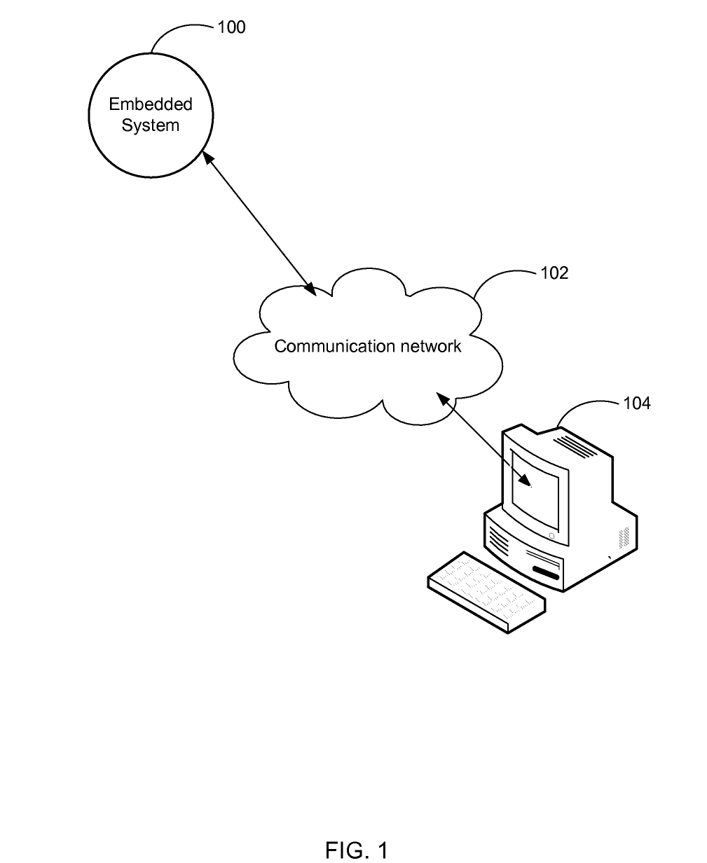

FIG. 1 shows an example of an embedded system 100 which is arranged to communicate with a computing device 104 over a communication network 102. The embedded system 100 stores a software application which includes instructions to allow the computing device 104 to interact with the embedded system 100. The software application is downloaded on to the computing device 104 via the communication network 102. The computing device 104 can execute the software application using its own processing capabilities. On executing the application, the computing device 104 interacts with the embedded system 100, for example downloading data from the embedded system 100 for processing or controlling the functions of the embedded system 100.

In other examples, the software application which allows interaction with the embedded system 100 may not be stored on the embedded system 100; the embedded system 100 may, for example, instead supply information over the communication network 102 to the computing device 104 about where the application may be located, for example by providing an IP address or the like. The computing device 104 may then access the software application from the location provided by the embedded system 100.

In known systems, in order to interact with a specific embedded system, the computing device 104 would have to contain software which contained instructions on how this interaction should be carried out. In the examples now described, the software application which is accessed from the embedded system 100 contains all the information necessary to allow the computing device 104 to further interact with the embedded system 100. The computing device 104 need not contain any software which is specific to that embedded system 100 ab initio; instead it simply comprises an execution environment arranged to retrieve and execute the software application received. As the software received by the computing device 104 can be executed thereon, it can therefore make use of the capabilities of the computing device 104, which may be superior to the capabilities of the embedded system 100.

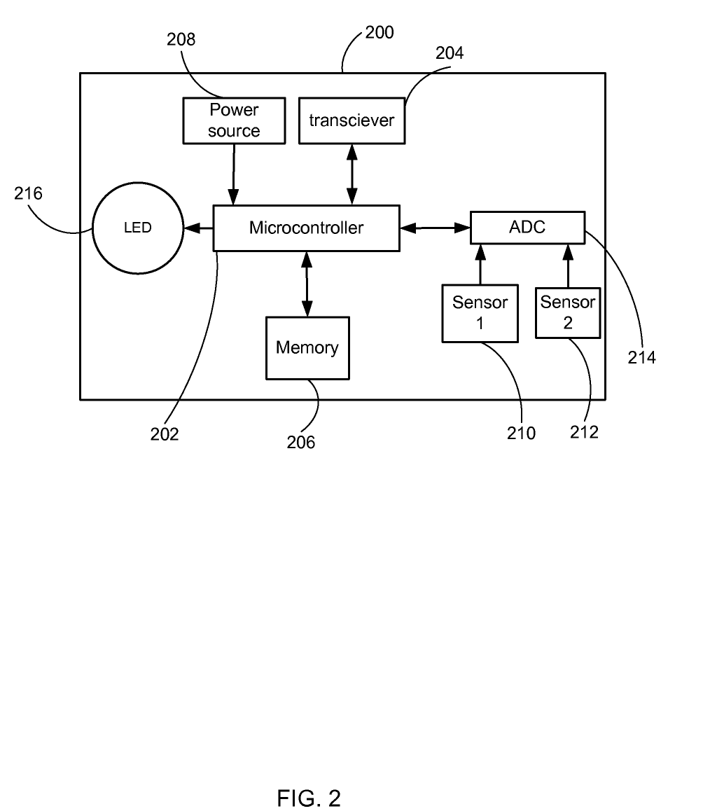

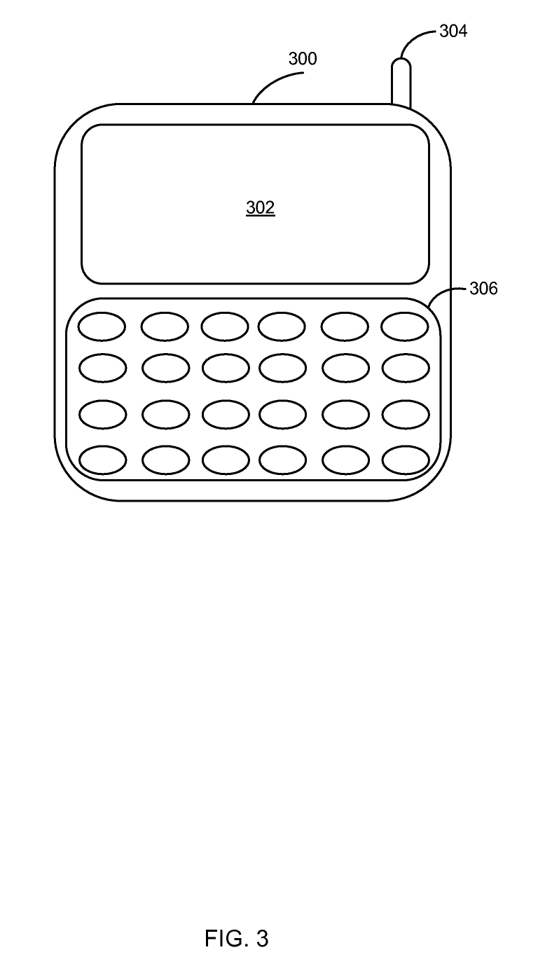

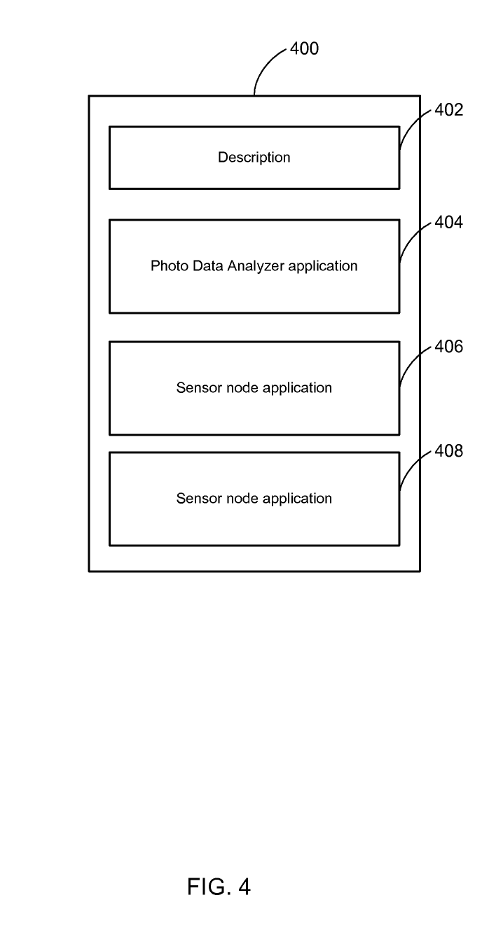

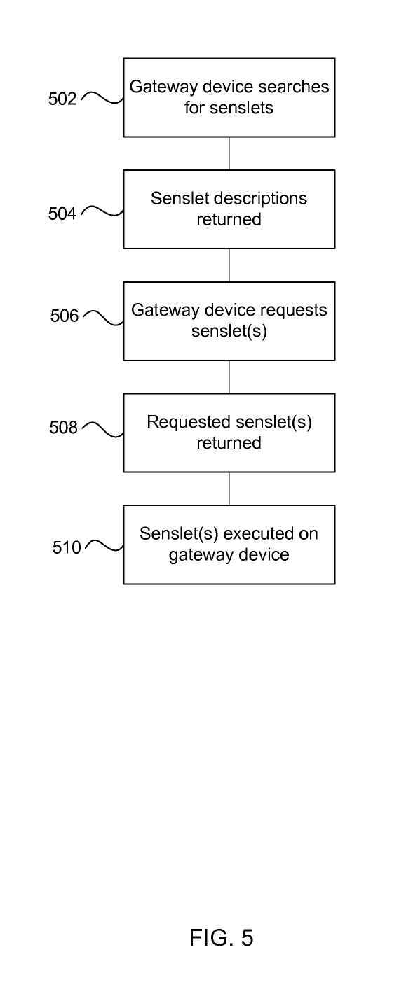

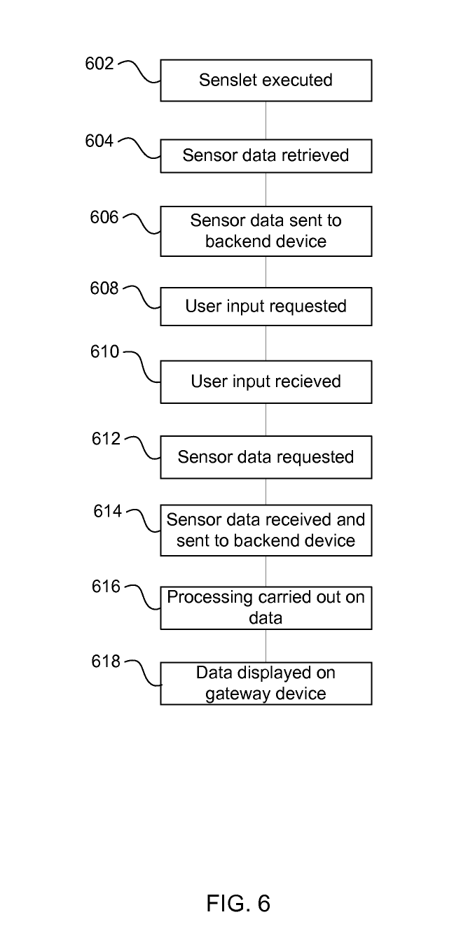

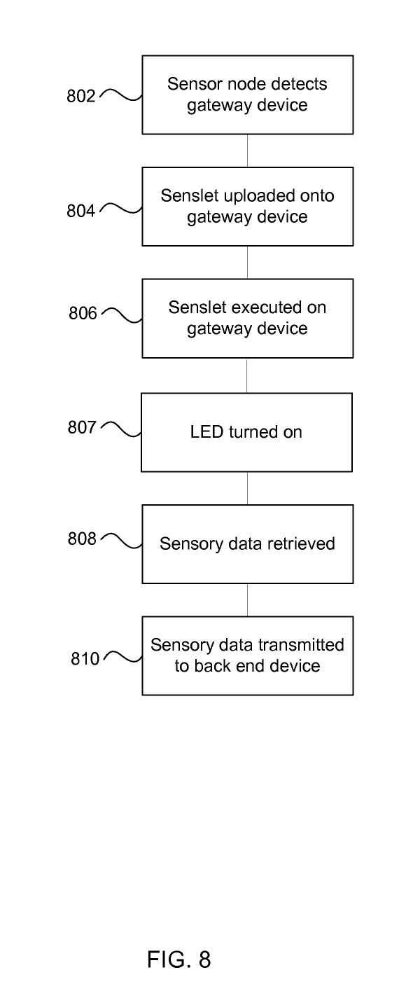

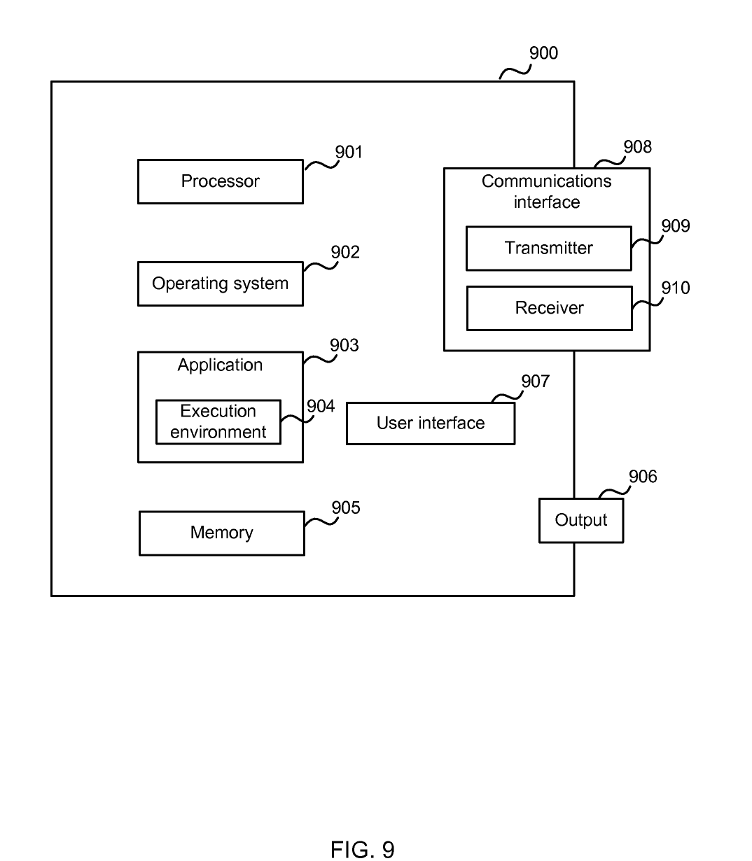

An example of an embedded system 100 is shown in FIG. 2 and examples of computing devices are shown in FIGS. 3 and 9. An example of a form in which software applications may be stored on an embedded system 100 is shown in FIG. 4. Processes of downloading applications are described in FIGS. 5 and 8 and processes of executing an application are described with reference to FIGS. 6 and 8.

FIG. 2 shows an example of an embedded system 100 comprising a sensor node 200. The sensor node 200 comprises a microcontroller 202, a transceiver 204, a memory 206, a power source 208, two sensors 210, 212, an Analog to Digital converter (ADC) 214 and an LED 216. In this example, the microcontroller 202 operates TinyOS. As will be familiar to the skilled person, TinyOS is an Open Source embedded operating system and platform for wireless sensor networks. TinyOS is written in the nesC (Network Embedded Systems C) programming language, which is an extension of the programming language C. TinyOS is a popular Operating System (OS) for sensor nodes/embedded systems but other examples may employ a different OS or a scheduler. As will be familiar to the skilled person, a scheduler orders jobs to be performed by a computing device and/or coordinates the use of shared resources. The OS or the scheduler may be arranged to run native programs which provides native software support; i.e. the memory 106 stores code which handles, for example, discovery and/or transmission of software to computing devices 104 which may provide a runtime environment for software, as is expanded upon herein after.

In this example, the sensors 210, 212 comprise a room sensor 210 arranged to sense temperature and humidity in a room and a light sensor 212 arranged to sense the level of light in a room.

FIG. 3 shows a PDA (Personal Digital Assistant) 300 which provides an example of a computing device 104. Computing devices which communicate with sensor nodes 200 are known in the art as ‘gateway’ computing devices. The PDA 300 comprises a screen 302, a transmitter antenna 304 which allows the PDA 300 to send and receive radio transmissions using Global Systems for Mobile communications (GSM), and a keypad 306. In this example, the PDA 300 is arranged to communicate with the sensor node 200 using the Bluetooth® protocol, but in other examples, other wireless or wired communication protocols may be used. The PDA 300 provides an execution environment, in this example, a browser, for executing applications retrieved from a sensor node 200 as is described below. The browser in this example is incorporated into a Web Browser such as Microsoft® Internet Explorer which is supplied with the PDA 300, but in other examples the execution environment may be a stand-alone application or incorporated into another application. The execution environment may be provided integrally with, or separately from the PDA 300, for example as an upgrade to the PDA 300.

The sensor node 200 is a resource constrained device of the type which typically uses low-level languages such as C/C++ or a domain-specific language. However, in the example now described, the sensor node 200 has software stored thereon which is programmed in a high-level language such as C# or Java, which will be more readily understood by programmers, and which is arranged to be executed on a gateway, backend or other computing device 104 such as the PDA 300. Therefore, the sensor node 200 does not require a resource-hungry virtual execution system which would be required to execute high-level code.

Such a high-level language application is termed a ‘senslet’ herein. As with an applet, a senslet is designed to be executed from within another application, rather than executed directly by the TinyOS operating system of the sensor node 200. A senslet will instead be executed on the PDA 300 and can utilize the resources of the PDA 300, such as the screen 302, keypad 306 or the wireless communication interfaces of the PDA 300. Senslets may contain application-level protocols for communicating with a sensor node 200.

A senslet may be provided as part of an embedded system application assembly called herein a senslet assembly 400, an example of which is shown schematically in FIG. 4 and which is stored in the memory 206 of the sensor node 200. In this example, the senslet assembly 400 is stored in program or external flash memory of a sensor node 200. This may save random access memory (RAM), which is typically very restricted on sensor nodes 200. As will be familiar to the skilled person, embedded systems 100 may have ‘extra’ flash memory for storing sensory data (i.e. data gathered by the sensors 210, 212). As will be familiar to the skilled person, flash memory is a type of Electrically Erasable, Programmable, Read-Only Memory (EEPROM). A sensor node 200 may contain such extra flash memory and/or other types of EEPROM for storing general data including sensory data, and may alternatively or additional comprise program flash memory accessible by the microcontroller. The senslet assembly 400 may have been developed using a tool for embedding senslet assemblies in the execution environment of a sensor node 200, which ensures that the senslet assembly 400 is stored in flash memory. Examples of processes for developing senslets are described in a co-pending US Patent Application, Microsoft Docket No. 322675.01, entitled ‘Framework for Programming Embedded System Applications’ which is incorporated herein by reference.

The assembly 400 comprises a description 402 of a set of senslets 404, 406, 408 contained therein. One of the senslets 404, 406, 408 is a light data analyzer senslet 404, the function of which is expanded upon below. The description 402 comprises senslet names, a human-readable description, and descriptions of specific properties such as energy usage or execution requirements of the senslets 404, 406, 408 contained in the senslet assembly 400. The senslet description 402 may also contain public keys which may be used by a computing device 104 to verify the trustworthiness of senslets 404, 406, 408.

Although in this example the senslet assembly 400 comprises a plurality of senslets 404, 406, 408, other examples may have more or fewer senslets 404, 406, 408. One or more senslet assemblies 400 may be included on a single sensor node 200 or other embedded system 100.

One example process of utilizing a senslet 404, 406, 408 is now described with reference to the flow diagram of FIG. 5. This example consists of three stages: (i) discovery, which attempts to locate any senslets, (ii) download of at least one senslet, and (iii) execution of at least one senslet. These stages are described in greater detail below. However, in other examples there may be different stages. For example, there may not be a discovery stage (for example if senslets 404, 406, 408 are already known to a computing device 104 or if the computing device 104 is informed of their existence rather than having to discover the senslets 404, 406, 408) and senslets 404, 406, 408 may be pushed or uploaded onto a computing device 104. In the case where senslet discovery is used, the sensor node 200 may include native programming to support the discovery, download and execution of senslets 404, 406, 408.

In this example, the PDA 300 searches for available senslets 404, 406, 408 (block 502) by sending out beacons, which in this example are wireless beacons according to the Bluetooth® protocol. If the PDA 300 is within range of the sensor node 200, the sensor node 200 receives the beacon and returns the description 402 of the senslets 404, 406, 408 (block 504). In this example, the description 402 contains an XML descriptor and the description is available without requiring download of a senslet 404, 406, 408. The screen 302 can then be used to display the retrieved description 402, which provides a list of the available senslets 404, 406, 408 and the user therefore can decide to execute one or more of these. In other examples, senslets 404, 406, 408 may be executed directly using an Application Program Interface (API) rather than displaying options on the screen 302.

If the user chooses to execute one or more senslets 404, 406, 408, a request for that/those senslet(s) 404, 406, 408 is sent to the sensor node 200 (block 506). The sensor node 200 returns the senslet(s) 404, 406, 408 (block 508), which is/are then executed within the execution environment, (i.e. in this example the browser application, which is available on the PDA 300 (block 510)). In this example, the senslet 404, 406, 408 is directly downloaded from a sensor node 200. However, in other examples, a sensor node 200 may for example contain a URL referencing a senslet 404, 406, 408 that may be downloaded from another computing device 104 such as a server on which the senslet 404, 406, 408 is stored.

In the above example, the user chooses to execute a senslet 404, 406, 408 before it is downloaded but in other examples, a senslet 404, 406, 408 could be requested, downloaded and then subsequently (for example following further user input) executed. In other examples, a request may not be sent and a senslet may be pushed onto a computing device 104. In still other examples, the discovery process may be initiated by the sensor node 200. In such examples, appropriate execution environment supporting the execution of senslets 404, 406, 408 may be discovered by the sensor node 200. Senslets may then be pushed to a computing device 104 which includes a senslet execution environment and be executed there without user intervention. This may be as specified by senslet properties contained in the senslet description. If the senslet 404, 406, 408 contains public keys, this information may also be utilized to determine whether the senslet 404, 406, 408 can be executed without explicit user intervention.

The senslets 404, 406, 408 contain application-level protocols to allow a computing device 104 to communicate with the sensor node 200, and therefore no pre-installed use-specific software (i.e. software specific to the capabilities of that sensor node) needs to be installed on the PDA 300 or other computing device 104 where the senslet 404, 406, 408 is to be run. The PDA 300 contains the browser application which is capable of hosting senslets 404, 406, 408 and all other information required to interact with the sensor node 200 is contained in the senslets 404, 406, 408. This may reduce the overhead for installing and maintaining computing devices 104 usually used to interact with embedded systems 100.

Senslets 404, 406, 408 may extend the capabilities of sensor nodes 200 and their uses. In some examples, a senslet 404, 406, 408 can dynamically make use of the resources of gateway and backend computing devices, and more generally make use of computing devices 104 around sensor nodes 200, as is described below with reference to the flow diagram of FIG. 6. In this example, a downloaded senslet 404 accesses the capabilities of the PDA 300. For example, the light data analyzer senslet 404 is downloaded and can cause a user interface to be displayed on the PDA screen 302, utilize the processing capability of the PDA 300 to carry out computations on behalf of the sensor node 200, and access the communication interfaces of the PDA 300 to communicate data to a backend infrastructure. The use of senslets 404, 406, 408 may also extend the lifetime of limited energy power sources 208 as energy consuming computations may be outsourced to a computing device 104.

Many software applications provided by backend or gateway computing devices 104 are programmed in a high-level language such as Java or C#. This is in contrast to known sensor node applications, which are typically programmed in C, C++, or derivatives of C (for example nesC for TinyOS). By storing a senslet 404, 406, 408 which is written in a high-level language on the sensor node 200, it is possible to ‘bridge the gap’ between Java- or C#-based backend or gateway computing device applications and low-level sensor code. Native senslet support may also be provided on the sensor node 200, which is not transferred to the computing device 100 and is instead natively executed on a sensor node 200 to handle, in the above example, senslet discovery and transmission of senslets 404, 406, 408 to the PDA 300.

In an example, the light data analyzer senslet 404 is associated with the light sensor 212. This senslet 404 has been downloaded onto the PDA 300. The senslet 404 thus gains access to the PDA's capabilities and enables the sensor node 200 to make use of the resources of the PDA 300. The use of the resources of the PDA 300 is exemplified in the example below by utilizing communication capabilities of the PDA 300, using the screen 302 to display a GUI and accepting user input using the keypad 306, using communication interfaces of the PDA 300 to send data to a backend infrastructure and by utilizing the processing circuitry of the PDA 300 to perform computations.

Although this example makes use of these four resources in combination, other examples could make use of one, two or three of these resources or other resources such as speakers, recorders, memory, or any other resources of a computing device 104. The light data analyzer senslet 404 is arranged to carry out the following processes, as set out in FIG. 6.

First, the senslet is executed (block 602). It will be recalled that the PDA 300 in this example has two communication interfaces (i) Bluetooth® used in interacting with sensor node 200 via short-range communication standards (other examples include IEEE 802.15.4 and IEEE 802.11) and (ii) GSM, which may be used for communicating with a backend computing device for central data storage, in this example a server. When the light data analyzer senslet 404 is executed on the PDA 300, all light data stored on the memory 206 of the sensor node 200 is retrieved by the PDA 300 (block 604) using Bluetooth® and sent to the server via GSM (block 606) which is then stored centrally. GSM and Bluetooth® are provided by way of example only and other examples may use other communication technologies, e.g. General Packet Radio Service (GPRS).

A senslet 404, 406, 408 may comprise instructions arranged to generate a user interface for displaying sensory data and for gathering input from a user. In this example, the light data analyzer senslet 404 is arranged to ask for a user input to indicate whether the room is too dark to work in, too bright to work in, or about right (block 608). These options are displayed on the screen 302 as a GUI and the user can provide an input using the keypad 306.

On receipt of the input (block 610), the light data analyzer senslet 404 sends a request for the light levels at that instant to the sensor 212 (block 612). This causes the sensor node 200 to measure and return a light level and, in this example, this information is sent to a backend computing device, specifically the server (block 614). The application-level protocol used by the PDA 300 for retrieving these values from the sensor node 200 is contained in the light data analyzer senslet 404. As a result, the PDA 300 does not need to have any preinstalled software to interact with a particular sensor node 200.

The retrieved and input data may subsequently be used to determine the level of lighting which should be set when any user enters the room based on an average result. In other examples, each user's preference may be associated with that user such that the lighting level can be controlled to a particular level corresponding to the user entering the room and based, for example, on the identity of the PDA 300. The level of light could be controlled using a communication interface to interact with the lighting control system in the room such as dimming the light bulbs, opening or closing blinds, etc. In other examples, the temperature or the humidity in the room could also be controlled, and/or this data could be used to verify that air conditioning, ventilation systems or the like are working adequately. Other computing devices 104 such as PCs or mobile devices including lap-top computers and mobile phones, typically offer a wide range of interface capabilities (keypads, thumbwheels, touch sensitive screens and the like), which can be exploited for displaying or interacting with a user interface generated on execution of a senslet 404, 406, 408.

Gateway computing devices typically possess considerably larger computational resources than sensor nodes 200 or other embedded systems 100. A senslet 404, 406, 408 may include instructions for carrying out complex, long-running computations that would cost considerable energy to execute on the sensor node 200 itself. These computations may be outsourced via the senslet 404, 406, 408 to a computing device 104. In this example, the light data analyzer senslet 404 contains instructions requesting that an average light level is determined along with its standard deviation and that a graph of temperature is plotted against time. The necessary calculations are carried out on data which has been retrieved from the light sensor 212 by a processor of the PDA 300 (block 616) and the result is displayed on the screen 302 of the PDA 300 (block 618). In other examples, temperature data may be accessed and the screen 302 of the PDA 300 may be used to display a history of temperature values in a room. This data can be used, for example, by a technician to adapt the heating in the room. Other examples of energy consuming computations may include Fast Fourier Transforms (FFT) or other signal processing algorithms. Such computation may be particularly energy consuming when sensory data is continuously streamed, for example from an accelerometer or a microphone. In some examples, senslets 404, 406, 408 may include complex signal processing algorithms.

Although in the above example a senslet 404, 406, 408 is downloaded by the PDA 300 which acts as a gateway computing device, in other examples a backend computing device may download senslets 404, 406, 408 directly from a sensor node 200, or via a gateway computing device.

Further, in the example described above, the user explicitly downloads a senslet 404, 406, 408 from the sensor node 200, but in other examples sensor nodes 200 may push senslets 404, 406, 408 to nearby computing devices 104, for example on detection of a suitable gateway computing device 104 in their vicinity. In either case, senslets 404, 406, 408 are executed in a hosting environment (the execution environment) on a computing device 104 and can use the capabilities of this computing device 104.

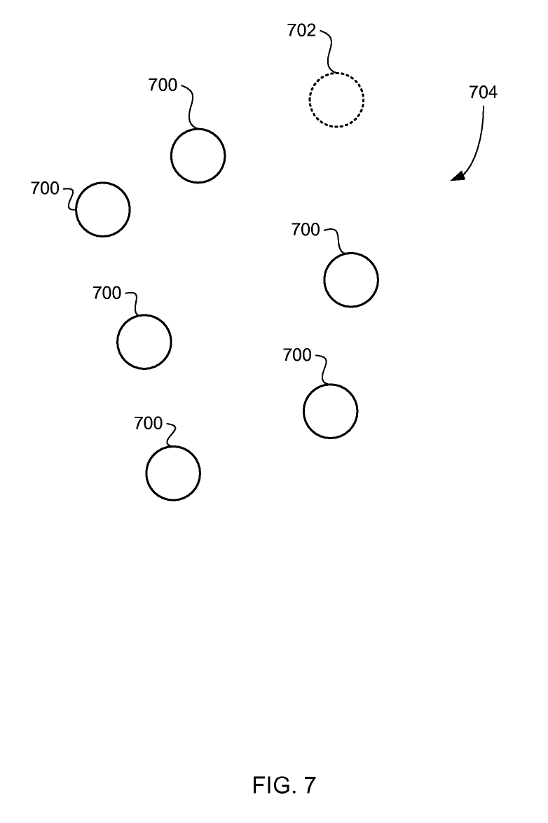

In an example now described with reference to FIG. 7, a plurality of sensor nodes 700, 702 are provided in an area, in this example a room of a building, and are arranged to record temperature data over time. The sensor nodes 700, 702 are connected using multihop communications technologies and form a wireless sensor network (WSN) 704. A subset of the sensor nodes 700, 702 (in this example, one sensor node 702) is programmed with at least one senslet assembly 400 whereas the remaining sensor nodes 700 are programmed in a known manner using a low level language, in this example nesC.

The process of gathering data from the WSN 704 is now described with reference to the flow diagram of a FIG. 8. A user with a PDA 300 incorporating a senslet execution environment such as a browser enters the room. The senslet programmed sensor node 702 detects the PDA 300 (block 802) using Bluetoothe protocols and pushes at least one senslet 404, 406, 408 onto the PDA 300 (block 804), where it is automatically executed by the senslet browser (block 806). The senslet 404, 406, 408 contains code which, when executed, causes an message to be sent to the sensor node 200 to turn the LED 216 on (block 807) and to retrieve a history of temperature data from the sensor nodes 700, 702 (block 808). In this example, the data is retrieved from each node 700, 702 but in other examples the data may have already been retrieved by the senslet programmed sensor node 702 and will be retrieved therefrom, or the data may be retrieved in some other manner.

The GSM wireless communication interface of the PDA 300 is used to transmit retrieved data to a backend system (block 810). As in the example described above, the user is presented with a GUI for directly interacting with the sensor nodes 700, 702, for example to request instant temperature measurements or the like. In some examples, once a computing device 104 has downloaded a senslet 404, it may be able to communicate with all the sensor nodes 700, 702 (i.e., not just the sensor node 702 that provided the senslet 404). In such examples, the senslet 404 may contain code for directly interacting with other sensor nodes 700, 702 within range (i.e. application-level protocols necessary to communicate directly with all sensor nodes 700, 702 in within range) and may contain code for interacting with other sensor nodes 700, 702 using, for example, multihop technology.

In this example, the senslet programmed sensor node 702 looks for platforms (i.e. a gateway device) on which to execute a senslet 404 and then pushes a senslet 404 to this gateway computing device 104: the discovery process is initiated by a sensor node 702. Discovery (in particular using Bluetooth®) requires a considerable amount of energy. In such embodiments, the senslet programmed sensor node 702 may have a long life, sustained or renewable power supply, such as a mains power supply.

The use of senslets 404, 406, 408 means that a user can utilize any computing device 104 that contains a senslet execution environment to interact with a sensor node 200. No use-specific code for a particular sensor node 200, 700, 702 need be preinstalled on the PDA 300 and no connection is required to download application code from a backend server or the like. It will be noted that there is no virtual machine on the sensor node 200 in the above examples.

Senslets 404, 406, 408 may contain the application level protocols to dynamically communicate with the sensor node 200. As in the example above, where a measurement is requested on receipt of a user input and an LED 216 is turned on, a gateway or backend computing device 104 can use the senslet 404, 406, 408 to dynamically interact with the sensor node 200. Runtime support may also be provided on sensors nodes 200, 700, 702 to enable communications between a senslet 404, 406, 408 and a sensor node 200, 700, 702.

There are many possible variations to the exemplary methods and apparatus described above. For example, the sensor node 200 shown in FIG. 1 has an ADC 214 but in other examples, sensors nodes 200 may not be connected via an ADC 214. Alternative examples include digital sensor nodes which are connected using, for example, an 12C serial bus or another interface.

A senslet assembly 400 may contain additional or alternative items, for example an identifier (ID), information about whether a senslet 404, 406, 408 is to be automatically downloaded to a computing device 104 after an appropriate computing device 104 has been found, and/or a flag which indicates whether the senslet 404, 406, 408 shall be automatically started on a computing device 104 after it has been downloaded or whether this should be triggered by a user. The senslet assembly 400 may also contain security information, such as a public key for validating the owner of the senslet or a hash value to ensure that the senslet assembly 400 or a senslet 404, 406, 408 has not been tampered with.

Senslets 404, 406, 408 may be associated with a range of embedded systems 100, including sensor nodes 200 which utilize alternative sensors to those described above. For example, sensors could for example measure salt levels, moisture or humidity in the environment or stress in solid structures. Other embedded systems may track factory processes, providing information about the movement of items along an assembly line or providing data about the workings of machinery. Embedded systems 100 may also control data transfer or other processes within an electronic appliance.

In the examples described above, the computing device 104 communicates with the sensor nodes 200, 700, 702 using Bluetooth®, which is a specific wireless communication technology, but other methods are possible. For example, a senslet 404, 406, 408, senslet description 402 and/or a URL which links to a senslet 404, 406, 408 could be retrieved using a graphical artifact captured by a camera of the PDA 300 or another computing device 104. When the senslet 404, 406, 408 is retrieved in this manner, there is no separate discovery process and instead the senslet 404, 406, 408 is pulled into the PDA 300. As there is no assessment of the suitability of the computing device to receive or to run the senslet 404, 406, 408 in such a scenario, uploading of the senslet 404, 406, 408 may fail or succeed. An example of a graphical artifact is a bar code. Such a transfer of information over a visual channel may also be considered as a wireless communication. In other examples, there may be a wired connection between an embedded system 100 and a computing device 104. Therefore, the beacons described above in relation to discovery of the sensor node 200 in FIG. 5 are not essential. A computing device 104 could discover a senslet 404, 406, 408 (or a embedded system 100 could discover a computing device 104) by other means, such as manually scanning a bar code, sending a signal over a wired connection, sending a beacon using a different wireless communication protocol or the like.

In one example, data may be provided as in two dimensional visual tags (or tag sequences) which may be captured using a camera of a computing device 104, for example a mobile camera phone. In particular, a room could be equipped with a tag at its entrance or a small display (e.g. a video display) which displays a sequence of tags. A description of senslets 404, 406, 408 available in the room may be encoded in the tag(s), possibly along with data required to access a sensor node 200 on which a senslet 404, 406, 408 is stored. When a user comes into a room, she/he uses the camera of her/his mobile phone or other computing device 104 to capture the tags. The computing device 104 may then directly access a sensor node 200 with a senslet 404, 406, 408, and retrieve and execute a senslet 404, 406, 408.

FIG. 9 illustrates various components of an exemplary computing-based device 900 which may be implemented as any form of a computing and/or electronic device, and in which embodiments of a gateway computing device or a backend computing device may be implemented.

The computing-based device 900 comprises one or more inputs 904 which are of any suitable type for receiving inputs such as an input from a sensor node 200 or another embedded system 100.

Computing-based device 900 also comprises one or more processors 901 which may be microprocessors, controllers or any other suitable type of processors for processing computing executable instructions to control the operation of the device in order to carry out the functions required to carry out the functions of a gateway computing device or a backend computing device. Platform software comprising an operating system 902 or any other suitable platform software may be provided at the computing-based device to enable application software 903 to be executed on the device 900. The application software comprises an execution environment 904 for executing a senslet 404, 406, 408.

The computer executable instructions may be provided using any computer-readable media, such as memory 905. The memory is of any suitable type such as random information memory (RAM), a disk storage device of any type such as a magnetic or optical storage device, a hard disk drive, or a CD, DVD or other disc drive. Flash memory, EPROM or EEPROM may also be used.

An output 906 may also be provided such as an audio and/or video output to a display system integral with or in communication with the computing-based device. The display system may provide a graphical user interface or other user interface 907 of any suitable type although this is not essential in all examples. The interface 907 allows inputs to be made to the computing-based device 900.

The computing-based device 900 further comprises a communication interface 908, which allows it to transmit and receive data over networks such as the Internet and/or telecommunication networks, for example for communicating with other entities such as other communications network nodes, gateway computing devices or backend computing devices. The communications interface 908 comprises a transmitter 909 and a receiver 910.

The term ‘computer’ and ‘computing device’ are used herein to refer to any device with processing capability such that it can execute instructions. Those skilled in the art will realize that such processing capabilities are incorporated into many different devices and therefore the term ‘computer’ and ‘computing device’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A computing device comprising a receiver, a processor, transmitter and a memory comprising executable instructions arranged to cause the processor to perform the steps of:
(i) receiving at least one embedded system application from an embedded system via the receiver;
(ii) executing the at least one embedded system application within an application execution environment, wherein the execution of the at least one embedded system application causes interaction between the computing device and the embedded system.

2. A computing device according to claim 1 which comprises a display device and in which the executable instructions are arranged to cause the processor to perform the step of displaying data on the display device on execution of the at least one application.

3. A computing device according to claim 1 and in which the executable instructions are arranged to cause the processor to perform the step of sending an instruction to the embedded system from which the embedded system application was received on execution of the application.

4. A computing device according to claim 3 in which the instruction comprises a request for data from the embedded system.

5. A computing device according to claim 1 in which the executable instructions are further arranged to cause the processor to perform the steps of using the transmitter to search for embedded systems.

6. A computing device according to claim 1 which is a portable computing device.

7. A computing device according to claim 1 in which the application execution environment comprises a browser.

8. A tangible computer readable medium comprising executable instructions arranged to provide an execution environment for executing an embedded system application on a computing device, wherein the executable instructions are arranged to perform steps comprising:
(i) discovering at least one embedded system application on an embedded system;
(ii) downloading the embedded system application from the embedded system onto the computing device;
(iii) executing the embedded system application on the computing device, wherein execution of the embedded system application allows interaction between the computing device and the embedded system.

9. A tangible computer readable medium according to claim 8 in which the step of discovering applications comprises sending a wireless beacon to query for embedded system applications.

10. A tangible computer readable medium according to claim 9 which comprises executable instructions for performing the steps of receiving a description of all discovered embedded system applications and sending a request for at least one of the discovered embedded system applications to be downloaded.

11. A tangible computer readable medium according to claim 8 which comprises executable instructions for performing the step of retrieving data from an embedded system on execution of an application.

12. A tangible computer readable medium according to claim 11 which comprises executable instructions for performing the step of processing the retrieved data on the computing device.

13. A tangible computer readable medium according to claim 8 which comprises executable instructions for performing the step of utilizing data received with the embedded system application to determine how the application is executed.

14. A tangible computer readable medium according to claim 8 which comprises executable instructions for performing the step of requesting user input on execution of an application.

15. A tangible computer readable medium according to claim 8 in which the execution of the application comprises the step of utilizing at least one of a display of the computing device and a communication interface of the computing device.

16. An embedded system application assembly on an embedded system comprising at least one embedded system application and a description of the at least one application, wherein the at least one application is written in a high-level programming language, the at least one application comprising device executable instructions which, when executed on a separate computing device, allow interaction between the computing device and the embedded system.

17. An embedded system application assembly according to claim 16 wherein the at least one application comprises device executable instructions which, when executed, utilize capabilities of the computing device.

18. An embedded system application assembly according to claim 17 which when executed utilizes at least one of a processor, display or input device of the gateway computing device.

19. An embedded system application assembly according to claim 16 wherein the application comprises device executable instructions which, when executed, allow data to be retrieved from at least one embedded system.

20. An embedded system application assembly according to claim 16 which is stored in flash memory of the embedded system.
